(19) United States
(12) Patent Application Publication
(10) Pub. No.: US 2002/0138579 A1
(43) Pub. Date: Sep. 26, 2002

(54) Method and system for completing e-mail transmissions

(76) Inventor: Bernol Goldberg, Jerusalem (IL)

Correspondence Address: WEISS & MOY PC, 4204 NORTH BROWN AVENUE, SCOTTSDALE, AZ, 85251, US

(21) Appl. No.: 09/811,497

(22) Filed: Mar. 20, 2001

(51) Int. Cl. G06F 15/16; G06F 17/00

(52) U.S. Cl. 709/206; 707/531

(57) ABSTRACT

A method and system for completing e-mail transmissions detects when an e-mail user likely intends to provide an attachment and prompts the user to provide the attachment if it is not attached. A parser parses the e-mail message for keywords that indicate that the sender likely intends to provide an attachment, then the e-mail program prompts the user to provide the attachment if the attachment is not attached. The parser may also decompose sentences to provide matching of common phrases or meanings with phrases or meanings that indicate that the sender likely intends to provide an attachment.

### BACKGROUND OF THE INVENTION

1. Field of the Invention

The present invention relates generally to electronic mail systems, and more specifically, to a method and system for completing e-mail transmissions by prompting a user for missing information.

2. Background of the Invention

Present-day network systems communicate through a variety of channels in order to interconnect computers. Electronic mail is in widespread use as a mechanism for communicating messages and for transferring documents and images.

E-mail programs and other programs such as Internet browsers having e-mail capability permit a computer user to create a message that is sent to an e-mail server for the recipient of the message. Typical e-mail programs permit the computer user to attach documents such as a word-processor output file or encoded images such as scanned photographs that are rendered in a data storage format such as the joint photography and electronics group (JPEG) format.

Often, a computer user generating an electronic mail message will intend to attach such a document and complete their message without attaching a file that is mentioned in the message.

Therefore, it would be desirable to provide a method and system for completing an e-mail transmission by using information contained within the e-mail message to prompt the user to complete the message.

### SUMMARY OF THE INVENTION

The above objective of completing e-mail messages is achieved in a method and system that receive a user input indicating that an e-mail message has been completed, parse the e-mail message for keywords indicating that an attachment to the e-mail message is likely intended, determine whether or not the attachment has been attached to the message, and in response to determining that the attachment has not been attached to the e-mail message, generating a user prompt to indicate to a user that an attachment to the e-mail message is likely intended. The method may be embodied in a computer program product for performing the method within a general purpose computer.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which a preferred embodiment of the invention may be practiced.

FIG. 2 is a pictorial diagram depicting output of an e-mail program displayed on the graphic display of FIG. 1, having a user prompt in accordance with a preferred embodiment of the invention.

FIG. 3 is a flowchart depicting operation of an e-mail completion system in accordance with a preferred embodiment of the invention.

### DETAILED DESCRIPTION OF THE PREFERRED EMBODIMENTS

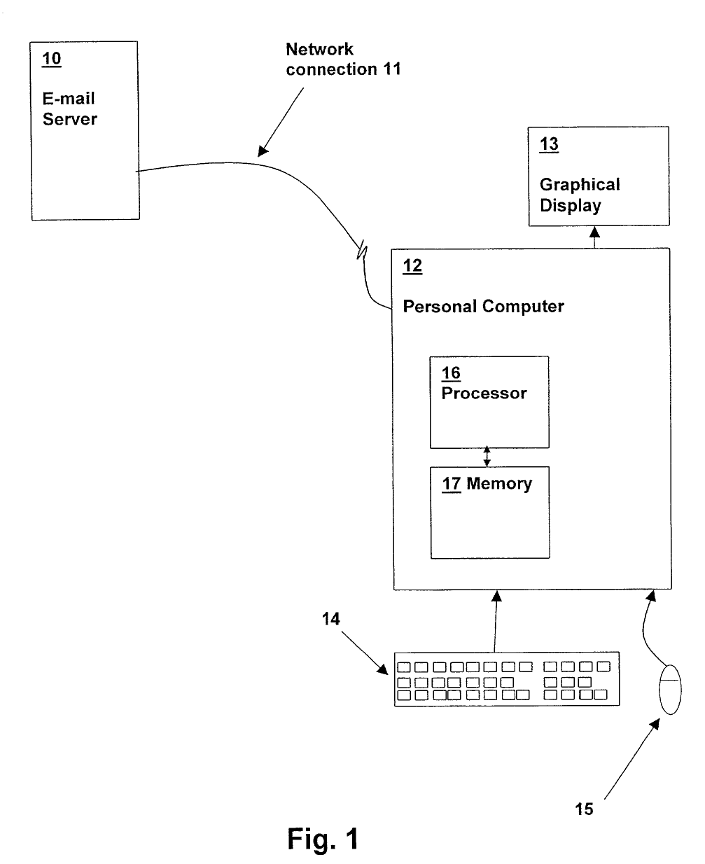

Referring now to the figures and in particular to FIG. 1, a networked computer system within which a preferred embodiment of the present invention may be practiced is depicted in a block diagram. To support e-mail functions, an e-mail server 10 is coupled to the network via a network connection 11. Also coupled to the network is a personal computer 12 having a processor 16 coupled to a memory 17 for executing program instructions from memory 17. Personal computer 12 is coupled to a graphical display 13 for displaying program output and input devices such as a mouse 15 and a keyboard 14 for receiving user input. The networked computer system may be coupled to a public network such as the Internet, or may be a private network such as the various “intra-nets” that are implemented within corporate offices and other installations requiring secure data communications.

Within memory 17, an e-mail program embodying a method in accordance with a preferred embodiment of the present invention is executed by processor 16. Personal computer 12 is included to provide a demonstrative example, and it will be understood by those skilled in the art that the techniques of the present invention may be extended to a variety of other e-mail applications such as dedicated Internet appliances and large mainframe computers having user terminals.

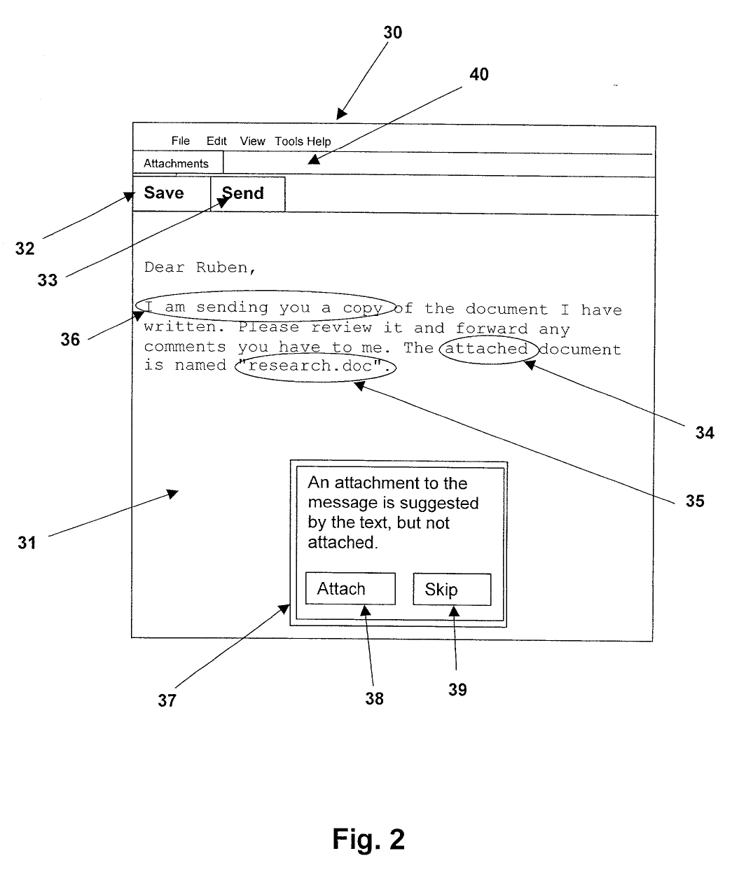

Referring now to FIG. 2, an output of an e-mail program in accordance with a preferred embodiment of the invention is depicted. While the invention is depicted with screens in American English language, the invention may be adapted to other languages and use clues that are localized to e-mail use in other languages and other countries. E-mail program output 30 forms a user output on graphical display 13 to permit a computer user to interact with the e-mail program executing within personal computer 12. E-mail program output 30 has a frame with menu options and a message area 31 for entering the text of e-mail messages via keyboard 14.

Within the exemplary e-mail message shown in message area 31, there are a variety of clues 34, 35, and 36 that the sender of the e-mail message intends to provide an attachment to be sent with the e-mail. An attachment area 40 is provided to add attachments to the e-mail, but at times an e-mail sender will forget to attach the attachment prior to sending the e-mail or saving the email for sending later. The e-mail message is sent by pressing a send button 33 in response to which the e-mail message and any attachments are sent to recipient's e-mail server 10. Or, the e-mail message may be saved for later transmission by pressing a save button 32. By parsing the e-mail message prior to sending or saving an e-mail message, the e-mail program can remind the sender to provide an attachment if any of clues 34, 35, or 36 indicate that an attachment is intended and the e-mail program does not find an attachment in attachment area 40.

There are a variety of clues that a sender intends to provide an attachment. Clue 34 is an example of a keyword clue: “attachment.” Other likely keywords are “attached”, “attach” “enclosed”, “exhibit”, “append”, “add”, “affix”, “copied” and so forth. A parser sub-program or plug-in within the e-mail program may look for a standard list of keywords, or a separate user interface may allow the e-mail user to customize the e-mail program or plug-in to search for a user-entered list of keywords. Once the e-mail user has customized the list of keywords, messages may be scanned for those keywords without prompting the user for keyword entry. A second type of clue is a filename clue 35. Filenames are often designated by file name extensions such as “.doc” or “.txt” that indicate the type of file. An e-mail sender may be prompted any time a file name is found by the parser and an attachment is not provided. Additionally, the parser may compare file names and determine whether or not the file is present within a list of attachments that have been provided. If no file name match is found, the user may be prompted to attach the file, or the e-mail program may find the file and ask whether or not the user wants to attach the file.

Another type of clue is the phrase clue 36. Phrase clues as in present exemplary clue 36 provide a syntactic clue that indicates that an attachment is intended such as “I am sending you a copy” or other phrases. Again, phrase clues may be entered by the user to customize a list of phrases similarly to the above-described key word entry, or a standard list of key phrases may be provided. Advanced parser mechanisms may be implemented within the parser to decompose sentences to determine whether or not phrase clues are present.

When the e-mail program has determined that the sender of the e-mail intends to provide an attachment but the attachment is not present, the user may be queried by a prompt dialog 37. Prompt dialog 37 notifies the user that an attachment was suggested by the message text and no attachment has been provided. The sender may then attach a file via attach button 38, which may open a file selection dialog or the user may elect to skip the attachment via skip button 39.

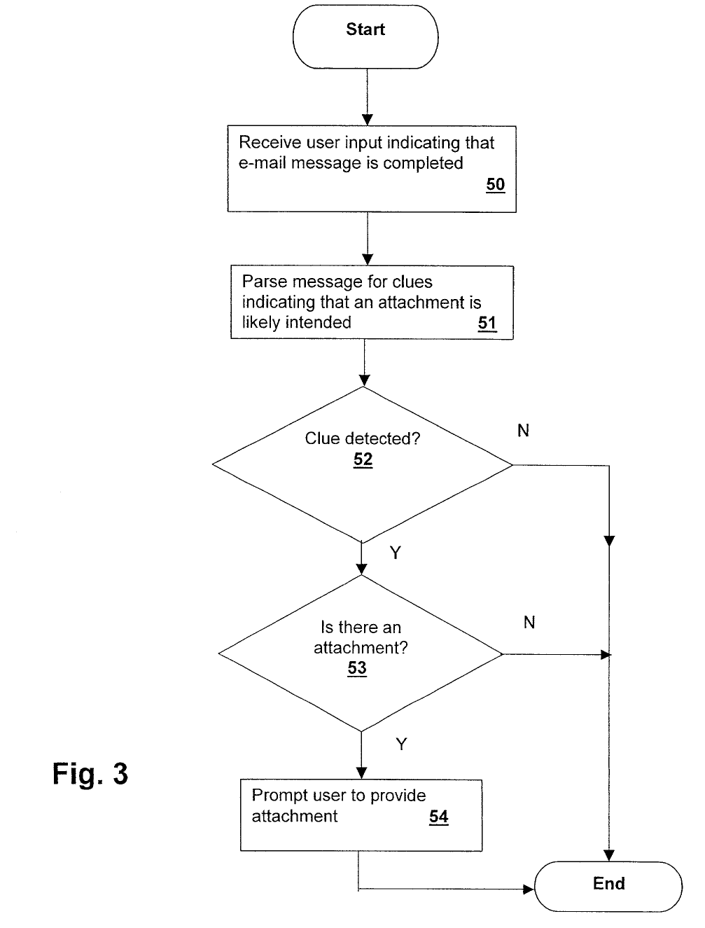

Referring now to FIG. 3 the e-mail completion system of the present invention is depicted in a flowchart. When the e-mail sender provides a user input indicating that an e-mail message is completed (step 50), the message text is parsed for clues indicating that an attachment is likely intended (step 51). If such a clue is found (decision 52) and an attachment is not present (step 53) the user is prompted to provide an attachment (step 54), otherwise the e-mail message is sent or saved in accordance with the user input in step 50. Note that the exemplary system depicted in the flowchart of FIG. 3 may be implemented in a variety of fashions. For example, the parsing may be skipped if an attachment is present, or the attachment scan may interact with the parser to prompt the user only if a particular file name is not found in the attachment list.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for completing an e-mail transmission, comprising:
receiving a user input indicating that an e-mail message has been completed;
parsing said e-mail message for clues indicating that an attachment to said e-mail message is likely intended;
determining whether or not said attachment has been attached to said message; and
in response to determining that said attachment has not been attached to said e-mail message, generating a user prompt to indicate to a user that an attachment to said e-mail message is likely intended.

2. The method of claim 1, wherein said user input indicating that said e-mail message has been completed is a user input instructing an e-mail program to send said e-mail message.

3. The method of claim 1, wherein said user input indicating that said e-mail message has been completed is a user input instructing an e-mail program to save said e-mail message.

4. The method of claim 1, wherein said clues comprise keywords and wherein said method further comprises collecting keywords from user input to create a set of keywords, and wherein said parsing is performed by matching members of said set of keywords with words within said e-mail message.

5. The method of claim 4, wherein said clues comprise file names, wherein said parsing detects file names within said e-mail message, and wherein said user prompt is generated to include a query asking said user whether or not a file specified by said file name should be attached to said e-mail message.

6. The method of claim 1, wherein said clues comprise phrases and wherein said parsing further includes decomposing sentences within said e-mail message to detect phrases indicating that an attachment to said e-mail message is likely intended.

7. The method of claim 6, wherein said clues comprise phrases and wherein said method further comprises collecting key phrases from user input to create a set of key phrases, and wherein said parsing is performed by matching members of said set of key phrases with sentences within said e-mail message.

8. A system for completing an e-mail transmission, comprising:
a memory for storing program instructions and data;
a processor coupled to said memory for executing said program instructions; and
a user input device coupled to said processor for receiving user input, wherein said program instructions include instructions for
receiving a user input indicating that an e-mail message has been completed,
parsing said e-mail message for clues indicating that an attachment to said e-mail message is likely intended,
determining whether or not said attachment has been attached to said message, and
in response to determining that said attachment has not been attached to said e-mail message, generating a user prompt to indicate to a user that an attachment to said e-mail message is likely intended.

9. The system of claim 8, wherein said user input indicating that said e-mail message has been completed is a user input instructing an e-mail program to send said e-mail message.

10. The system of claim 8, wherein said user input indicating that said e-mail message has been completed is a user input instructing an e-mail program to save said e-mail message.

11. The system of claim 8, wherein said clues comprise keywords, wherein said program instructions further comprise instructions for collecting keywords from user input to create a set of keywords, and wherein said program instructions for parsing match members of said set of keywords with words within said e-mail message.

12. The system of claim 8, wherein said clues comprise file names, wherein said program instructions for parsing detect file names within said e-mail message, and wherein said program instructions for generating a user prompt generate a query asking said user whether or not a file specified by said file name should be attached to said e-mail message.

13. The system of claim 8, wherein said clues comprise phrases, and wherein said program instructions for parsing further include program instructions for decomposing sentences within said e-mail message to detect phrases indicating that an attachment to said e-mail message is likely intended.

14. The system of claim 13, wherein said clues comprise phrases, and wherein said system further comprises program instructions for collecting key phrases from user input to generate a set of key phrases and wherein said program instructions for parsing match members of said set of key phrases with sentences within said e-mail message.

15. A computer program product comprising signal-bearing media containing program instructions for execution within a general purpose computer, wherein said program instructions comprise program instructions for:
receiving a user input indicating that an e-mail message has been completed,
parsing said e-mail message for clues indicating that an attachment to said e-mail message is likely intended,
determining whether or not said attachment has been attached to said message, and
in response to determining that said attachment has not been attached to said e-mail message, generating a user prompt to indicate to a user that an attachment to said e-mail message is likely intended.

16. The computer program product of claim 15, wherein said user input indicating that said e-mail message has been completed is a user input instructing an e-mail program to send said e-mail message.

17. The computer program product of claim 15, wherein said user input indicating that said e-mail message has been completed is a user input instructing an e-mail program to save said e-mail message.

18. The computer program product of claim 15, wherein said clues comprise keywords, wherein said program instructions further comprise instructions for collecting keywords from user input to create a set of keywords, and wherein said program instructions for parsing match members of said set of keywords with words within said e-mail message.

19. The computer program produce of claim 15, wherein said clues comprise phrases, and wherein said program instructions for parsing further include program instructions for decomposing sentences within said e-mail message to detect phrases indicating that an attachment to said e-mail message is likely intended.

20. The computer program product of claim 15, wherein said clues comprise phrases, and further comprising program instructions for collecting key phrases from user input to generate a set of key phrases and wherein said program instructions for parsing match members of said set of key phrases with sentences within said e-mail message.
